(19) United States
(12) Patent Application Publication
(10) Pub. No.: US 2025/0056156 A1
(43) Pub. Date: Feb. 13, 2025

(54) SYSTEM FOR MITIGATING MECHANICAL RATTLE

(71) Applicant: Cirrus Logic International Semiconductor Ltd., Edinburgh (GB)

(72) Inventors: Peter FOSKEY, Austin, TX (US); Kurt EFAW, Austin, TX (US); Brad ZWERNEMANN, Austin, TX (US); Enrique PEREZ BENAVIDES, Austin, TX (US); Andrew RUMELT, Austin, TX (US); Christopher JACKSON, Austin, TX (US); Marco A. JANKO, Austin, TX (US); William E. SHERWOOD, Salt Lake City, UT (US); James E. BARKULOO, Lynn Haven, FL (US)

(73) Assignee: Cirrus Logic International Semiconductor Ltd., Edinburgh (GB)

(21) Appl. No.: 18/795,418

(22) Filed: Aug. 6, 2024

Related U.S. Application Data
(60) Provisional application No. 63/518,639, filed on Aug. 10, 2023.

(51) Int. Cl. H04R 3/04; G10K 11/175; G10L 25/18

(52) U.S. Cl. CPC H04R 3/04; G10K 11/1752; G10L 25/18; H04R 2430/01

(57) ABSTRACT

A computer having a system for mitigating mechanical rattle arising due to a mechanical coupling of an audio output transducer to a part of the computer device, the system comprising: a processing subsystem configured to receive an input audio signal and to output a drive signal for driving the audio output transducer to produce a transducer output, wherein the processing subsystem is configured to selectively apply an attenuation function to the input audio signal to attenuate a signal component of the input audio signal at a frequency that causes mechanical rattle in the computer; and an analyser subsystem configured to receive the input audio signal and to output a control signal to the processing subsystem to control application of the attenuation function to the input audio signal by the processing subsystem based on a spectral content of the received input audio signal; wherein the attenuation function is based on characteristic acoustic behaviour of the computer.

### FIELD OF THE INVENTION

The present disclosure relates to a system for mitigating mechanical rattle, for example in a computer such as a laptop or tablet computer or an all-in-one desktop computer. The present disclosure further relates to a computer such as a laptop or tablet computer or an all-in-one desktop computer comprising a system for mitigating mechanical rattle.

### BACKGROUND

Computing devices such as laptop computers, tablet computers and all-in-one desktop computers typically contain one or more acoustic transducers (e.g. loudspeakers) for generating audible outputs from an audio system of the device. The acoustic transducer(s) are typically mechanically coupled to (e.g. mounted on) a part of the device, e.g. a frame, chassis, casing or housing of the device.

Due to size, design and manufacturing constraints, these speaker mounting configurations typically allow low frequency energy in the audio spectrum from the audio output by the acoustic transducer to translate directly into the frame, chassis, casing or housing of the device with minimal damping. Depending on the spectral content of a signal output by the audio system to the acoustic transducer, this leakage of energy from the acoustic transducer can cause mechanical resonance of the whole or part of the device to which the transducer is mechanically coupled, generating secondary noise.

A result of this mechanical resonance is audible distortion (which may be referred to as mechanical rattle) that may be detrimental to the experience of a user of the device and may reduce audio fidelity in the output of the acoustic transducers.

Systems have been developed for reducing distortion introduced by a speaker. Such systems may use a masking scheme to reduce mid-band frequency content in an audio signal supplied to the speaker when high frequency content is low compared to mid-band frequency content. Such systems generally apply time domain analysis and attenuate a broad range of frequencies, which may be selected based on arbitrary and subjective tuning. However, such mid-band attenuation can be perceived by a listener as a large volume reduction. Additionally, any masking content that may be added to the audio signal to mask distortion may be perceived by a listener as unwanted coloring of sound.

Moreover, although such systems may reduce or mask distortion introduced by the speaker itself, they do not address the problem of mechanical resonance or rattle arising due to a mechanical coupling of an audio output transducer (e.g. a speaker) to part of a host device such as a computing device.

### SUMMARY

According to a first aspect, the invention provides a computer having a system for mitigating mechanical rattle arising due to a mechanical coupling of an audio output transducer to a part of the computer device, the system comprising: a processing subsystem configured to receive an input audio signal and to output a drive signal for driving the audio output transducer to produce a transducer output, wherein the processing subsystem is configured to selectively apply an attenuation function to the input audio signal to attenuate a signal component of the input audio signal at a frequency that causes mechanical rattle in the computer; and an analyser subsystem configured to receive the input audio signal and to output a control signal to the processing subsystem to control application of the attenuation function to the input audio signal by the processing subsystem based on a spectral content of the received input audio signal; wherein the attenuation function is based on characteristic acoustic behaviour of the computer.

The processing subsystem may be further configured to selectively apply an amplification function to the input audio signal to amplify a signal component of the input audio signal at a frequency that masks an effect of mechanical rattle in the computing device.

The analyser subsystem may comprise a classifier configured to classify the input audio signal into one or more classes based on the spectral content of the input audio signal and to output a control signal to the processing subsystem to control application of the attenuation function to the input audio signal by the processing subsystem based on the classification of the input audio signal.

The classifier may comprise a neural network or machine learning model trained to identify features of the input audio signal that are characteristic of each of the one or more classes and to classify the input audio signal based on identified features of the input audio signal.

The classifier may comprise a neural network or machine learning model trained to identify features of the input audio signal that are characteristic of each of the one or more classes. The classifier may be configured to determine a metric relating to identified features of the input audio signal and to classify the input audio signal based on the metric.

The analyser subsystem may be configured to output the control signal in response to detection of spectral content in the input audio signal at a level above a rattle threshold at a frequency that could give rise to mechanical rattle in the computing device.

The analyser subsystem may be configured to determine a first ratio of high-frequency content to low-frequency content of the input audio signal and/or a second ratio of low-frequency content to high-frequency content of the input audio signal, and to output a control signal to the processing block to control application of the attenuation function based on the determined first and/or second ratio.

The analyser subsystem may be configured to perform a fast Fourier Transform (FFT) on the input audio signal to generate a frequency-domain representation of the input audio signal received by the analyser block.

The analyser subsystem may be configured to output the control signal in response to detection of a signal peak in the frequency domain representation of the input audio signal at a frequency that could give rise to mechanical rattle in the computing device.

The analyser subsystem may be configured to output the control signal in response to detection of a signal peak in the frequency domain representation of the input audio signal at a level above a rattle threshold at a frequency that could give rise to mechanical rattle in the computing device.

The analyser subsystem may be configured to determine a ratio of a level of a detected high-frequency signal peak in the frequency-domain representation of the input audio signal to a level of a detected low-frequency signal peak in the frequency-domain representation, and to output the control signal if the determined ratio exceeds a frequency content ratio threshold.

The analyser subsystem may be configured to prevent the processing subsystem from applying the attenuation function in response to detection of spectral content in the input audio signal at a frequency that may mask mechanical rattle in the computer.

The analyser subsystem may be configured to prevent the processing subsystem from applying the attenuation function in response to detection of spectral content in the input audio signal at a level above a rattle-masking threshold at a frequency that may mask mechanical rattle in the computer.

The analyser subsystem may be configured to output a control signal to cause the processing subsystem to apply the amplification function in response to detection of spectral content in the input audio signal at a frequency that may mask mechanical rattle in the computer.

The input audio signal may be a digital signal comprising a plurality of frames. For each frame of the input audio signal, the analyser subsystem may be operative to output a control signal to the processing subsystem to control application of the attenuation function or to prevent the processing subsystem from applying the attenuation function based on the spectral content of the frame.

The processing subsystem may comprise one or more filters configured to implement the attenuation function.

The or each filter may comprise a narrowband filter.

The or each filter may comprise a dynamically reconfigurable filter having a controllable transfer function. The processing subsystem may be configured to control the transfer function of the or each dynamically reconfigurable filter based on a control signal received from the analyser subsystem.

The or each filter may comprise a time domain-filter or a frequency-domain filter.

The processing subsystem may be configured to selectively apply one or more masks to the input audio signal based on the classification of the input audio signal by the classifier. The or each mask may be configured to implement an attenuation function to attenuate rattle-causing spectral content in the input audio signal to optimise or improve a property of the transducer output signal.

The processing system may be configured to apply a first mask to optimise or improve fidelity of the transducer output in response to a classification of the audio input signal as music, and to apply a second mask to optimise or improve intelligibility of the transducer output in response to a classification of the audio input signal as speech.

The computer may comprise an input transducer. The processing subsystem may be configured to: receive a feedback signal from the input transducer; detect distortion in the transducer output based on the feedback signal; and in response to detection of distortion in the transducer output, apply the attenuation function and/or an amplification function to the audio input signal.

The processing subsystem may be configured to monitor one or more of a sound pressure level of the transducer output and baseband content and associated harmonics of the transducer output based on the feedback signal to detect distortion in the transducer output.

The processing subsystem may be configured to apply the attenuation function according to an attack/release function.

The processing subsystem may be configured to progressively apply the attenuation function to the input audio signal over a period of time, from a minimum attenuation level to a maximum attenuation level such that the maximum attenuation level is applied to spectral content of the input audio signal at a frequency that could give rise to mechanical rattle in the computing device.

The processing subsystem may be configured to selectively apply the attenuation function in the time domain or in the frequency domain based on the classification of the input signal by the classifier.

The processing subsystem may be configured to apply the attenuation function in the time domain in response to a classification of the audio input signal as speech, and to apply the attenuation function in the frequency domain in response to a classification of the audio input signal as music.

The processing subsystem may be configured to selectively apply the attenuation function in the time domain or in the frequency domain based on identification of features of the input audio signal by the analyser subsystem.

The processing subsystem may be configured to apply the attenuation function in the time domain in response to identification of feature of the audio input signal indicative that the audio input signal represents speech, and to apply the attenuation function in the frequency domain in response to identification of features of the audio input signal indicative that the audio input signal represents music.

The computer may be, for example, a laptop computer, a tablet computer or an all-in-one desktop computer.

According to a second aspect, the invention provides a method for evaluating characteristic acoustic behaviour of a computer comprising an audio output transducer, the method comprising the steps of: supplying a stimulus signal to the audio output transducer; monitoring the computer to detect a mechanical resonance effect in the computer; and generating a distortion frequency profile for the computer based on a frequency and amplitude of the stimulus signal for which a mechanical resonance effect in the computing device was detected.

The monitoring of the computing device to detect a mechanical resonance effect may be performed using an input transducer of the computer.

The stimulus signal may comprise a plurality of tones spaced apart in frequency.

According to a third aspect, the invention provides a system for mitigating mechanical rattle in a computer arising due to a mechanical coupling of an audio output transducer to a part of the computer, the system comprising: a processing subsystem configured to receive an input audio signal and to output a drive signal for driving the audio output transducer to produce a transducer output, wherein the processing subsystem is configured to selectively apply an attenuation function to the input audio signal to attenuate a signal component of the input audio signal at a frequency that causes mechanical rattle in the computer, wherein the attenuation function is based on characteristic acoustic behaviour of the computer.

According to a fourth aspect, the invention provides a system for mitigating mechanical rattle in a computer arising due to a mechanical coupling of an audio transducer to a part of the computer, the system comprising: a classifier subsystem configured to classify the audio input signal into one or more of a plurality of classes; and a processing block configured to selectively apply an attenuation function to the input signal to attenuate a signal component of the input audio signal according to the classification of the audio input signal.

According to a fifth aspect, the invention provides a system for mitigating mechanical rattle in a computer arising due to a mechanical coupling of an audio transducer to a part of the computer, the system comprising: a classifier subsystem configured to classify the audio input signal into one or more of a plurality of classes; and a processing block configured to apply an attenuation function of a plurality of attenuation functions to the input signal to attenuate a signal component of the input audio signal, wherein the processing block is configured to select the attenuation function based on the classification of the audio input signal.

According to a sixth aspect, the invention provides a system for mitigating mechanical rattle in a computer arising due to a mechanical coupling of an audio transducer to a part of the computer, the system comprising: a classifier subsystem configured to classify the audio input signal into one or more of a plurality of classes; and a processing block configured to selectively apply an attenuation function to the input signal to attenuate a signal component of the input audio signal, wherein the processing block is configured to apply either a frequency domain attenuation function or a time-domain attenuation function according to the classification of the audio input signal.

According to a seventh aspect, the invention provides a system for mitigating mechanical resonance in a host device arising due to a mechanical coupling of an audio output transducer to a part of the host device, the system comprising: a processing subsystem configured to receive an input audio signal and to output a drive signal for driving the audio output transducer to produce a transducer output, wherein the processing subsystem is configured to selectively apply an attenuation function to the input audio signal to attenuate a signal component of the input audio signal at a frequency that causes mechanical resonance in the host device.

According to an eighth aspect, the invention provides an integrated circuit implementing the system of any of the third to seventh aspects.

The integrated circuit may comprise a smart amplifier integrated circuit.

According to a ninth aspect, the invention provides a host device comprising the system of any of any of the third to seventh aspects.

The host device may comprise, for example, a laptop, notebook, netbook or tablet computer, an all-in-one computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device, or a vehicle.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic diagram illustrating the principle of mechanical resonance mitigation in an audio system of a host device in accordance with the present disclosure;

FIG. 2 is a schematic representation of an example of a mechanical resonance mitigation subsystem;

FIG. 3 is a schematic representation of an example of a mechanical resonance mitigation subsystem showing details of an analyser block;

FIG. 4 is a schematic representation of an example of a mechanical resonance mitigation subsystem showing details of an alternative analyser block;

FIG. 5 is a schematic representation of an example of a mechanical resonance mitigation subsystem showing details of a processing block;

FIG. 6 is a schematic representation of an example of a mechanical resonance mitigation subsystem showing details of an alternative processing block;

FIG. 7 is a schematic representation of a further example of a mechanical resonance mitigation subsystem;

FIG. 8 is a schematic representation of an example of a mechanical resonance mitigation subsystem with a feedback arrangement; and

FIG. 9 is a flow chart showing steps in a method for determining or evaluating characteristic behaviour of a host device for a mechanical resonance subsystem of the kind illustrated in FIGS. 2-8.

### DETAILED DESCRIPTION

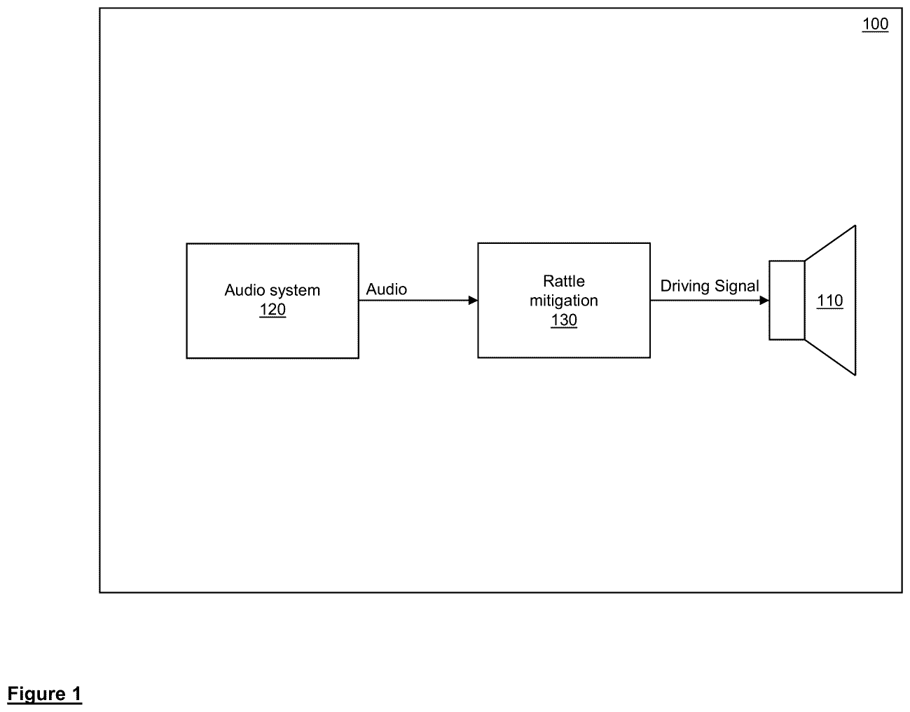

FIG. 1 is a schematic diagram illustrating the principle of mechanical resonance or rattle mitigation in an audio system of a host device in accordance with an aspect of the present disclosure.

As shown in FIG. 1, a host device 100, such as a laptop, tablet or all-in-one desktop computer, includes one or more audio output transducers 110 such as speakers, and an audio system 120 configured to generate an audio signal for driving the audio output transducer 110 to generate an audible output.

The audio output transducer 110 is mechanically coupled to (e.g. mounted on or attached to) a part of the host device 100, e.g. a frame, chassis, casing or housing of the host device 100.

The audio signal generated by the audio system 120 may represent, for example, speech from an audio or video telephony software application running on the host device 100, music from a music player application running on the host device 100, or sound effects and/or speech and/or music from a game or video player application running on the host device 100. The audio signal may be a digital audio signal or an analog signal. A digital audio signal may comprise a plurality of frames of audio data, each frame comprising one or more samples of an analog audio signal.

As noted above, the mounting arrangement of the audio output transducer 110 can give rise to mechanical rattle as a result of mechanical resonance of the host device 100 (or part of the host device 100) when an audio signal containing signal content at certain frequencies is supplied to the audio output transducer 110.

To reduce or mitigate the problem of mechanical rattle, the host device 100 includes a mechanical rattle mitigation subsystem 130. Although shown separately from the audio system 120 in FIG. 1, the mechanical rattle mitigation subsystem 130 may form part of the audio system 120 of the host device 100. Alternatively, the mechanical rattle mitigation subsystem 130 may be a standalone subsystem of the host device 100. The mechanical rattle mitigation subsystem 130 may be implemented in hardware (e.g. as one or more integrated circuits, or as discrete circuitry), or may be implemented in software running on appropriately configured hardware (e.g. firmware running on a digital signal processor integrated circuit (IC) or IC block, smart amplifier IC or IC block or the like).

The mechanical rattle mitigation subsystem 130 is configured to receive an audio signal output by the audio system 120 and selectively apply an attenuation function to this input audio signal to generate a driving signal to be output to the audio output transducer 110 to generate an audible output. The attenuation function applies frequency-specific attenuation to the received input audio signal to attenuate signal components of the input audio signal at one or more frequencies that cause mechanical rattle in the host device 100. Additionally or alternatively, the mechanical rattle mitigation subsystem 130 may also be configured to selectively apply an amplification function to the input audio signal to generate the driving signal. The amplification function amplifies signal components of the input audio signal at frequencies that mask mechanical rattle in the host device 100. The attenuation function may be implemented, for example, by one or more filters included in or implemented by the mechanical rattle mitigation subsystem 130. The amplification function may be implemented by controlling a gain of one or more of the one or more filters.

An attenuation function and/or an amplification function may be selectively applied by the mechanical rattle mitigation subsystem 130 to the input audio signal on a frame-by-frame basis, such that different attenuation functions may be applied to different frames of the input audio signal. For example, for an audio signal comprising first, second and third frames, a first attenuation function and/or amplification function may be applied to the first frame, a second attenuation function and/or amplification function (different from the first attenuation function and/or amplification function) may be applied to the second frame, and no attenuation function may be applied to the third frame (but an amplification function may be applied to the third frame).

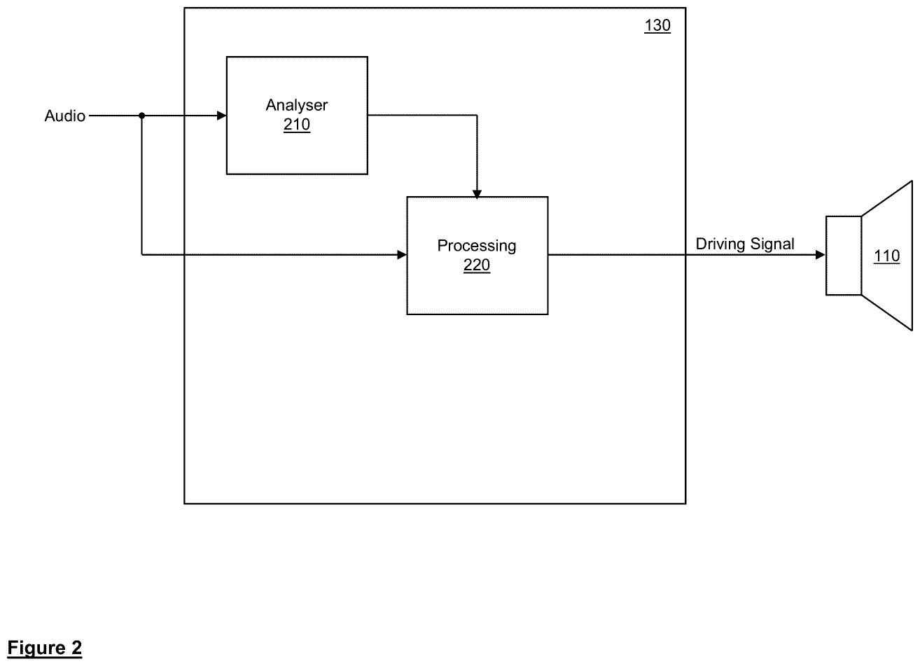

FIG. 2 is a schematic representation of an example of a mechanical rattle mitigation subsystem 130 suitable for use in the host device 100 of FIG. 1.

In the example shown in FIG. 2, the mechanical rattle mitigation subsystem 130 includes an analyser block or subsystem 210 and a processing block or subsystem 220. The analyser block 210 and the processing block 220 may each be implemented in hardware (e.g. in one or more integrated circuits or in discrete circuitry), or may be implemented in software running on appropriately-configured hardware (e.g. firmware running on a digital signal processor integrated circuit (IC) or IC block, smart amplifier IC or IC block or the like). In a specific example, the analyser block 210 and the processing block 220 are both implemented in software or firmware executed by a digital signal processor (DSP) or smart amplifier integrated circuit (IC) or IC block.

The analyser block 210 is configured to receive an input audio signal from an audio system of a host device (e.g. the audio system 120 of the host device 100 of FIG. 1), to analyse the spectral content of the received input audio signal, and to output a control signal to the processing block 220 to control processing applied to the input audio signal by the processing block 220 based on the spectral content of the received input audio signal.

The analyser block 210 is configured to detect spectral content in the input audio signal at one or more frequencies or frequency bands that may give rise to mechanical rattle in the particular host device in which the audio output transducer 110 is incorporated.

In some examples, the analyser block 210 is configured to output a control signal to the processing block 220 if any spectral content is detected in the input audio signal at a rattle-causing frequency. In other examples, the analyser block 210 is configured to compare a level (e.g. an amplitude) of the detected spectral content at a rattle-causing frequency to a first rattle threshold, and to output a control signal to the processing block 220 only if the level of the detected spectral content at the rattle-causing frequency is greater than the first rattle threshold.

Depending on the properties and/or configuration of the host device 100, it may be that spectral content in the input audio signal at two or more frequencies or frequency bands may give rise to mechanical rattle in the host device 100. In such cases, the level of spectral content in the input audio signal at a first frequency or frequency band that will give rise to mechanical rattle may be different than the level of spectral content at a second frequency or frequency band that will give rise to mechanical rattle. Thus, the analyser block 210 may be configured to compare the level of spectral content in the input audio signal at a first rattle-causing frequency or frequency band to a first rattle threshold, and to compare the level of spectral content in the input audio signal at a second rattle-causing frequency or frequency band to a second rattle threshold that is different from the first rattle threshold.

In the event that the level of spectral content at the first rattle-causing frequency or frequency band is greater than the first rattle threshold, the analyser block 210 may output a first control signal to the processing block 220. In the event that the level of spectral content at the second rattle-causing frequency or frequency band is greater than the second rattle threshold, the analyser block 210 may output a second control signal (which is different from the first control signal) to the processing block 220. In the event that the level of spectral content at the first rattle-causing frequency or frequency band is greater than the first rattle threshold and the level of spectral content at the second rattle-causing frequency or frequency band is greater than the second rattle threshold, the analyser block 210 may output a third control signal (which is different from the first and second control signals) to the processing block 220. In other words, the control signal output by the analyser block 210 to the processing block 220 may be indicative of, or dependent on, the presence or level of spectral content detected by the analyser block 210 at the frequencies or frequency bands that cause mechanical rattle in the particular host device 100.

The analyser block 210 may be further configured to detect spectral content in the input audio signal at one or more frequencies or frequency bands that may mask mechanical rattle (when converted to an audible output by the audio output transducer 110) in the host device 100. In some examples, if spectral content at such a masking frequency (or frequencies) is detected, the analyser block 210 may output no control signal to the processing block 220, or may output a fourth control signal indicating that no processing is to be applied to the input audio signal by the processing block 220, thereby preventing the processing block 220 from applying the attenuation function. In other examples, the analyser block 210 may be configured to compare a level of such spectral content to a rattle-masking threshold. If the level of the detected spectral content at a masking frequency or frequencies is greater than the rattle-masking threshold, the analyser block 210 may output no control signal to the processing block 220, or may output a fourth control signal indicating that no processing is to be applied to the input audio signal by the processing block 220, thereby preventing the processing block 220 from applying the attenuation function.

In some examples, if spectral content at one or more masking frequencies is detected, the analyser block 210 may output a fifth control signal to the processing block 220, indicating that the processing block 220 is to apply an amplification function to the input audio signal, to amplify signal components of the input audio signal at the detected one or more masking frequencies, such that spectral content of the input audio signal at one or more frequencies or frequency bands that may mask mechanical rattle when converted to an audible output by the audio output transducer 110 is amplified, thereby increasing the sound pressure level of such spectral content and increasing the rattle-masking effect in the output of the audio output transducer 110.

In other examples, the analyser block 210 is configured to calculate, estimate or otherwise determine a ratio of high-frequency content (e.g. signal components at frequencies above a predefined high-frequency content threshold) to full-frequency content (i.e. the total spectral content of the input audio signal) in the input audio signal, and to output a control signal to the processing block 220 to control the processing applied to the input audio signal by the processing block 220, e.g. to cause the processing block 220 to apply an attenuation function if the determined ratio falls below a high-frequency to full-frequency ratio threshold.

High-frequency content in the input audio signal above a certain level may be sufficient to mask mechanical rattle, and thus the high-frequency to full-frequency ratio threshold is determined based on a level of high-frequency content in the input audio signal that is sufficient to mask mechanical rattle that may arise when the input audio signal is supplied to the audio output transducer 110. As will be appreciated by those of ordinary skill in the art, the level of high-frequency audio content in the input audio signal that is sufficient to mask mechanical rattle is dependent upon the configuration and resonant properties of the particular host device 100 in which the audio output transducer 110 is incorporated.

Alternatively or additionally, the analyser block 210 may be configured to calculate, estimate or otherwise determine a ratio of low-frequency content (e.g. signal components at frequencies below a predefined low-frequency content threshold) to high-frequency content, and to output a control signal to the processing block 220 to control the processing applied to the input audio signal by the processing block 220 based on the determined ratio, e.g. to cause the processing block 220 to apply an attenuation function if the determined ratio is above a low-frequency to high-frequency ratio threshold.

A high ratio of low-frequency content to high-frequency content may be indicative that there is insufficient masking content in the input audio signal to mask mechanical rattle that may arise when the input audio signal is supplied to the audio output transducer 110. As noted above, high-frequency content in the input audio signal above a certain level may be sufficient to mask mechanical rattle, and thus the low-frequency to high-frequency ratio threshold is determined based on the level of high-frequency content in the input audio signal that is sufficient to mask mechanical rattle in the host device 100 that may arise when the input audio signal is supplied to the audio output transducer 110. Also as previously noted, the level of high-frequency audio content in the input audio signal that is sufficient to mask mechanical rattle is dependent upon the configuration and resonant properties of the particular host device 100 in which the audio output transducer 110 is incorporated.

Where the input audio signal is a digital audio signal the analyser block 210 may be operative to analyse the digital audio signal on a frame-by-frame basis and to output a control signal (or no control signal) as described above for each frame of the digital audio signal.

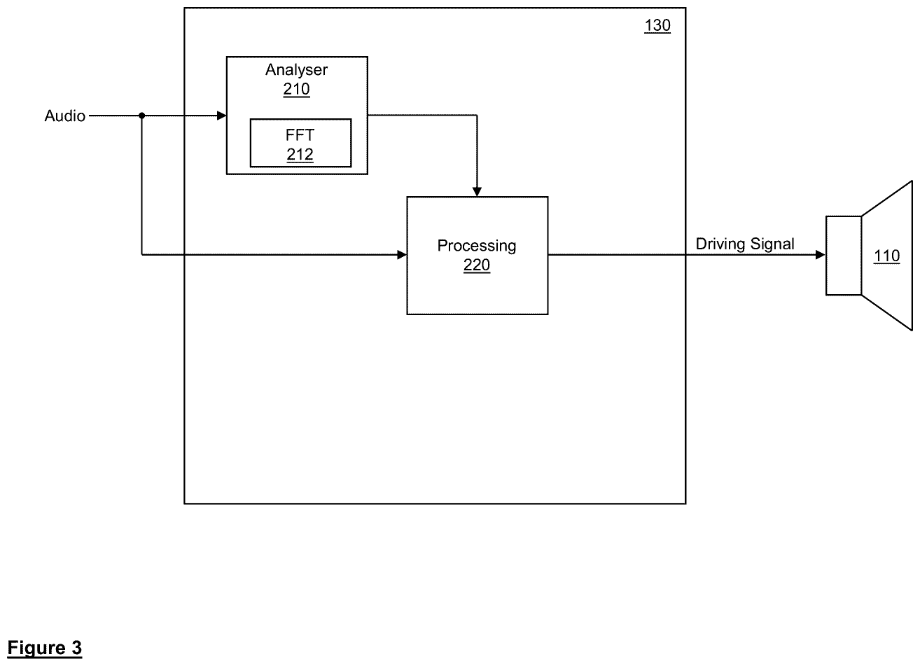

The analyser block 210 may be implemented in a number of different ways. In one example, illustrated in FIG. 3, the analyser block 210 includes a Fast Fourier Transform (FFT) block 212 (which may be implemented in hardware (e.g. in suitably configured discrete or integrated circuitry) or software (e.g. in software or firmware running on a digital signal processor, ASIC, general-purpose processor or the like) configured to perform an FFT on the input audio signal to generate a frequency-domain representation of the time-domain input audio signal received by the analyser block 210.

The analyser block 210 may be configured to analyse the frequency-domain representation of the input audio signal to detect signal peaks in the frequency-domain representation of the input audio signal at one or more rattle-causing frequencies or frequency bands. Upon detection of such signal peaks, the analyser block may output a control signal to the processing block 220 as described above. Alternatively, the analyser block 210 may be configured to compare a level (e.g. amplitude) of the or each detected signal peak to a respective threshold, and may output a second or third control signal to the processing block 220, the detected signal peak(s) exceed the threshold(s), as described above.

In a further alternative example, the analyser block 210 may be configured to calculate, estimate or otherwise determine a ratio of the level (e.g. amplitude) of one or more detected high-frequency signal peaks to the level (e.g. amplitude) of one or more detected low-frequency signal peaks, and may output a control signal to the processing block 220 if the determined ratio exceeds a frequency content ratio threshold.

The analyser block 210 may also be configured to analyse the frequency-domain representation of the input audio signal to detect signal peaks at one or more masking frequencies or frequency bands. Upon detection of such signal peaks, the analyser block may output no control signal to the processing block 220 as described above, such that no processing is applied to the input audio signal by the processing block 220. Alternatively, the analyser block 210 may be configured to compare the magnitude (e.g. amplitude) of the or each detected signal peak at a masking frequency or frequency band to a respective threshold, and may output a fifth control signal to the processing block 220 indicating that the processing block 220 is to amplify the input audio signal at the detected one or more masking frequencies if the detected signal peak(s) exceed the threshold(s), as described above.

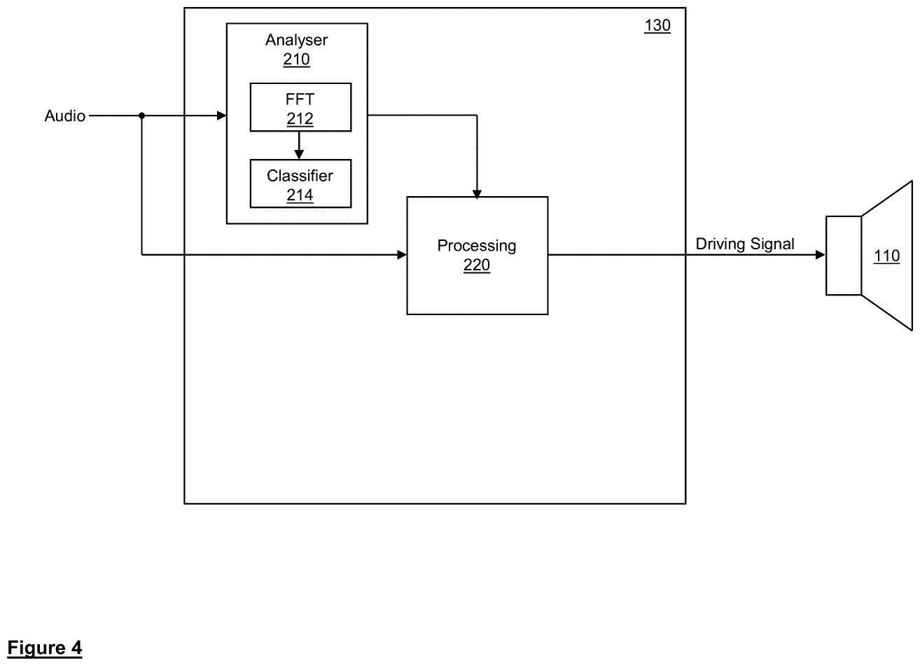

In another example, illustrated in FIG. 4, the analyser block 210 comprises a classifier block 214 or subsystem (which may be implemented in hardware (e.g. in suitably configured discrete or integrated circuitry) or software (e.g. in software or firmware running on a digital signal processor, ASIC, general-purpose processor or the like) configured to classify the input audio signal into one or more classes according to its spectral content, and to output a control signal to the processing block 220 control the processing applied to the input audio signal by the processing block 220, based on the classification of the input audio signal.

For example, the classifier block 214 may be configured to classify the input audio signal into one or more of the following classes: pure tone signal; multitone signal; single instrument music; multi-instrument music; speech. If the classifier block 214 classifies the input audio signal into the pure tone signal class, it outputs a first control signal to the processing block 220 to cause the processing block 220 to apply processing appropriate to a pure tone signal to the input audio signal. Similarly, if the classifier block 214 classifies the input audio signal into the multitone signal class, it outputs a second control signal to the processing block 220 to cause the processing block 220 to apply processing appropriate to a multitone signal to the input audio signal, whilst if the classifier block classifies the input audio signal into the single instrument music class, the multi-instrument music class or the speech class, it outputs a respective third, fourth, or fifth control signal to cause the cause the processing block 220 to apply processing appropriate to the class of the input audio signal. Where the input audio signal is a digital audio signal, the classifier block 214 may be operative to classify the digital audio signal on a frame-by-frame basis so as to classify each frame of the digital audio signal and output an appropriate control signal for each frame of the digital audio signal.

In some examples, the classifier block 214 is configured to receive a frequency domain representation of the input audio signal (e.g. from an FFT block 212 of the kind described above with reference to FIG. 3) and to perform the classification of the input audio signal into the one or more classes based on the received frequency domain representation of the input audio signal. In other examples, the classifier block 214 is configured to receive the input audio signal, and to perform the classification of the input audio signal into the one or more classes based on the input audio signal without any transformation into the frequency domain.

The classifier block 214 may be implemented in a number of different ways. In one example, the classifier block 214 comprises an artificial neural network or machine learning model that has been trained or otherwise configured to identify features of the input audio signal or a frequency domain representation of the input audio signal such as frequency peaks (i.e. signal level peaks at particular frequencies in the input signal) that are particular to or characteristic of each of the one or more classes, and to classify the input audio signal into the relevant class accordingly. Those of ordinary skill in the art will readily understand how to configure and train an artificial neural network or machine learning model to identify such particular or characteristic features of the input signal (or a frequency domain representation of the input signal) and to classify the input audio signal into the one or more classes based on the identified features. Further, those of ordinary skill in the art will readily appreciate that many different features of the input audio signal (or a frequency domain representation of the input audio signal) other than frequency peaks could be identified to enable classification of the input audio signal.

Additionally or alternatively, the classifier block 214 may be configured to estimate, calculate or otherwise determine one or more metrics relating to such features, such as a frequency peak count (a metric indicative of the number of frequency peaks within one or more specific frequency bands), a difference or ratio of frequency peak counts between different frequency bands, e.g. between a high-frequency band (which may be defined as a frequency band above a first threshold frequency) and a low-frequency band (which may be defined as a frequency band below the first threshold frequency or below a second threshold frequency that is lower than the first threshold frequency) and to classify the input audio signal based on the determined metric(s).

In an alternative example, the classifier block 214 may be implemented in hardware (e.g. in suitably configured discrete or integrated circuitry) or software (e.g. in software or firmware running on a digital signal processor, ASIC, general-purpose processor or the like) using digital and/or analog signal processing techniques to identify features of the input audio signal (or a frequency domain representation of the input audio signal) and classify the input audio signal based on the identified features and/or metrics related to the identified features. Those of ordinary skill in the art will readily understand how to implement the classifier block 214 using such signal processing techniques.

The processing block 220 is configured to receive the input audio signal and the control signal output by the analyser block 210 and to process the input audio signal in accordance with the control signal to generate a driving signal for supplying to an audio output transducer 110 of the host device.

The processing performed by the processing block 220 mitigates mechanical rattle by selectively applying an attenuation function to the input audio signal to attenuate signal components of the input audio signal at one or more frequencies that cause mechanical rattle in the host device 100. The processing performed by the processing block may, additionally or alternatively, apply an amplification function to the input audio signal to amplify signal components of the input audio signal at one or more frequencies that mask mechanical rattle in the host device 100. Where the input audio signal is a digital audio signal the processing block 220 may be operative to process the digital audio signal on a frame-by-frame basis so as to apply appropriate processing to each frame of the digital audio signal.

The attenuation function applied by the processing block 220 is specific to the particular host device 100 in which the audio output transducer is integrated, and is based on characteristic acoustic behaviour of the particular host device 100. A method for determining an attenuation function (or a plurality of attenuation functions) for a particular host device 100 based on the characteristic acoustic behaviour of that particular host device 100 is described in detail below.

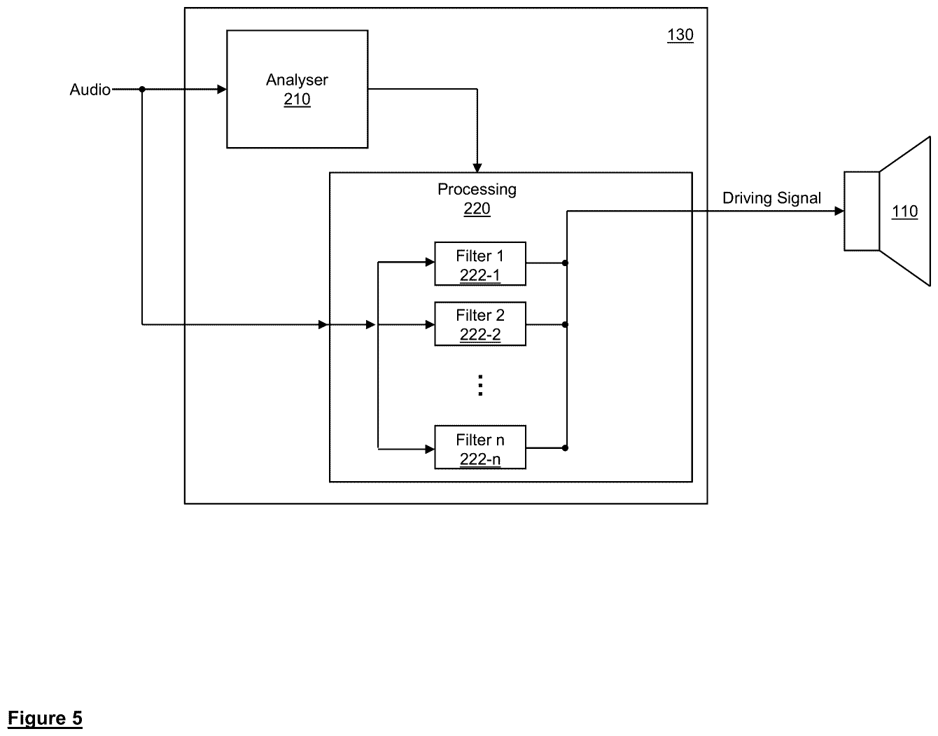

As shown in FIG. 5, the processing block 220 may comprise a plurality of filters 222-1-222-n, configured to implement one or more device-specific attenuation functions for the particular host device 100 in which the audio output transducer 110 is incorporated. The plurality of filters 222-1-222-n may be configured as time-domain filters or as frequency-domain filters.

Each of the plurality of filters 222-1-222-n may be a band stop filter, configured to block or attenuate signal components at frequencies within a respective different frequency range (referred to as the stop band of the filter) and to pass signal components at frequencies outside of the stop band. Alternatively, each of the plurality of filters 222-1-222-n may be a band pass filter, configured to pass signal components at frequencies within a respective different frequency range (referred to as the pass band of the filter) and to stop or attenuate signal components at frequencies outside the pass band.

The plurality of filters 222-1-222-n may be narrowband filters, in the sense that the stop band or pass band of each of the plurality of filters may have a relatively narrow bandwidth (e.g. 50 Hz, 100 Hz, 200 Hz). By using a plurality of narrowband filters, the attenuation applied to the input audio signal can be confined to one or more narrow frequency bands, thus minimising attenuation of the input audio signal in frequency bands for which attenuation is not required, therefore minimising or at least reducing (in comparison to known techniques) any reduction in sound pressure level of the audio output at the audio output transducer 110 and accordingly minimising or a least reducing any loss of volume of the audio output. Additionally, the use of a plurality of narrowband filters may reduce the perception of unwanted coloring of the output audio, by confining the attenuation applied to the input audio signal to one or more narrow frequency bands.

The plurality of filters 222-1-222-n may be arranged in a filter bank, for example. The plurality of filters may be implemented in digital or analog circuitry (which may be integrated in one or more integrated circuits), or may be implemented in software running on appropriately configured hardware (e.g. firmware running on a digital signal processor IC or IC block, smart amplifier IC or IC block or the like).

As described above, the control signal output by the analyser block 210 to the processing block 220 may be dependent on detection, by the analyser block 210, of spectral content in the input audio signal at one or more rattle-causing frequencies, and/or on detection, by the analyser block 210, of rattle-masking spectral content in the input audio signal. Additionally or alternatively, the control signal output by the analyser block 210 to the processing block may be dependent on the classification of the input audio signal by the classifier block 214, if present.

The processing block is operative to apply an attenuation function based on the control signal output by the analyser block 210. In one example, the processing block 220 is configured to selectively activate or enable one or more of the plurality of filters 222-1-222-n based on the control signal received from the analyser block 210 for a given input audio signal.

For example, if the control signal is indicative that spectral content (or spectral content at a level above the first rattle threshold, if applicable) at a single rattle-causing frequency or frequency range is present in the input audio signal (e.g. if the control signal is a first or second control signal of the kind described above), the processing block 220 may be operative to activate or enable the filter of the plurality of filters 222-1-222-n that is configured to block or attenuate signal components at the rattle-causing frequency or frequency range of the detected spectral content of the audio signal.

Similarly, if the control signal received from the analyser block 210 is a third control signal of the kind described above, indicating that spectral content at both a first rattle-causing frequency or frequency band and a second rattle-causing frequency or frequency band is present in the input audio signal (at a level above the first and second rattle thresholds, if applicable), the processing block 220 may be operative to activate or enable the filters of the plurality of filters 222-1-222-n that are configured to block or attenuate signal components at the first and second rattle-causing frequencies or frequency ranges.

If no control signal is received from the analyser block 210, or if the control signal is a fourth control signal of the kind described above, indicating that spectral content at one or more frequencies or frequency bands that may mask mechanical rattle is present in the input audio signal, the processing block 220 may be operative not to activate or enable any of the plurality of filters 222-1-222-n, such that no processing is applied to the input audio signal by the processing block.

If the control signal received from the analyser block 210 is a fifth control signal of the kind described above, indicating that the input audio signal contains spectral content at one or more masking frequencies or frequency ranges that should be amplified, the processing block 220 may be operative to apply an amplification function to the input audio signal. The amplification function may be applied by increasing a gain of those filters of the plurality of filters 222-1-222-n that are configured to pass signal components at the masking frequencies or frequency ranges to a value greater than unity, such that the spectral content of the input audio signal at the masking frequencies is amplified by the processing block 220.

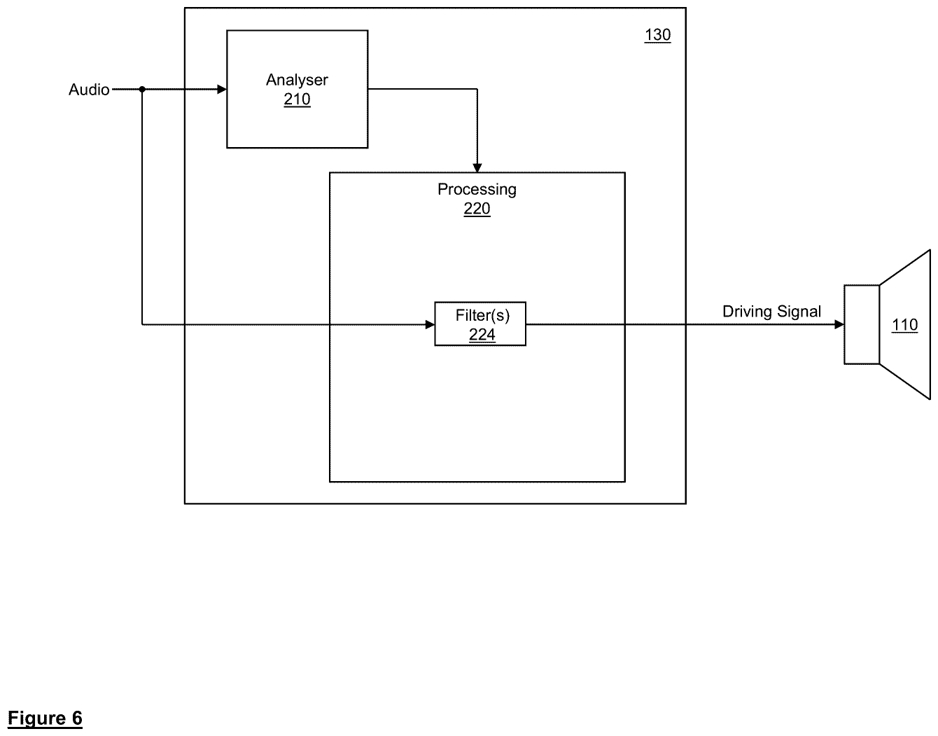

In another example, illustrated in FIG. 6, the processing block may include one or more dynamically reconfigurable filters 224, which may be implemented in digital or analog circuitry (which may be integrated in one or more integrated circuits), or may be implemented in software running on appropriately-configured hardware (e.g. firmware running on a digital signal processor IC or IC block, smart amplifier IC or IC block or the like). Or each dynamically reconfigurable filter 224 may be configured as a time-domain filter or as a frequency-domain filter.

A transfer function of the (or each) dynamically reconfigurable filter 224 may be dynamically reconfigurable, such that the dynamically reconfigurable filter 224 can implement a plurality of different attenuation functions. The transfer function of the dynamically reconfigurable filter 224 is controlled or selected by the processing block 220 based on the control signal received by the processing block 220 from the analyser block 210.

For example, if the control signal is indicative that spectral content (or spectral content at a level above the first rattle threshold, if applicable) at a single rattle-causing frequency or frequency range is present in the input audio signal or in a current frame of the input audio signal (e.g. if the control signal is a first or second control signal of the kind described above), the processing block 220 may be operative to cause the dynamically reconfigurable filter 224 to adopt a first transfer function in which the dynamically reconfigurable filter 224 is configured as a band stop filter to block or attenuate signal components at the rattle-causing frequency or frequency range of the detected spectral content of the input audio signal.

Similarly, if the control signal received from the analyser block 210 is a third control signal of the kind described above, indicating that spectral content at both a first rattle-causing frequency or frequency band and a second rattle-causing frequency or frequency band is present in the input audio signal (at a level above the first and second rattle thresholds, if applicable), the processing block 220 may be operative to cause the dynamically reconfigurable filter 224 to adopt a second transfer function to configure the dynamically reconfigurable filter 224 to block or attenuate signal components at the first and second rattle-causing frequencies or frequency ranges.

If no control signal is received from the analyser block 210, or if the control signal is a fourth control signal of the kind described above, indicating that spectral content at one or more frequencies or frequency bands that may mask mechanical rattle is present in the input audio signal, the processing block 220 may be operative to cause the dynamically reconfigurable filter 224 to adopt a third transfer function in which the dynamically reconfigurable filter 224 acts as a unity-gain all-pass filter, such that no processing is applied to the input audio signal by the processing block 220.

If the control signal received from the analyser block 210 is a fifth control signal of the kind described above, indicating that the input audio signal contains spectral content at one or more masking frequencies or frequency ranges that should be amplified, the processing block 220 may be operative to apply an amplification function to the input audio signal, e.g. by causing the dynamically reconfigurable filter 224 to adopt a fourth transfer function in which the dynamically reconfigurable filter 224 acts as a multi-band band pass filter with a gain greater than unity in the pass bands, such that the dynamically reconfigurable filter 224 is configured to pass signal components at the masking frequencies or frequency ranges, such that the spectral content of the input audio signal at the masking frequencies is amplified by the processing block 220.

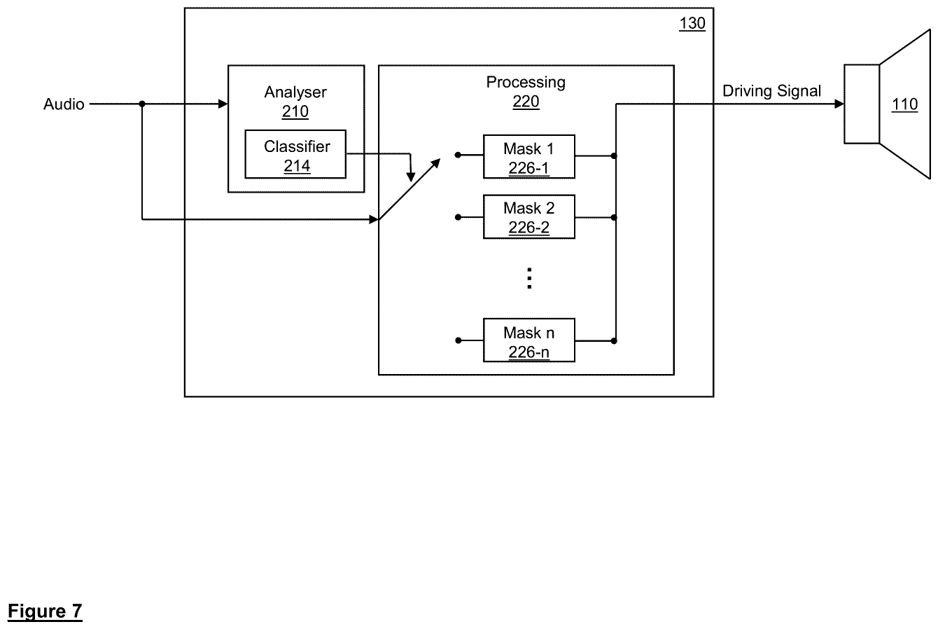

In another example (illustrated in FIG. 7), where the analyser block 210 includes a classifier block 214, the processing block 220 may be configured to selectively apply one or more of a plurality of masks 226-1-226-n to the input audio signal, based on the classification of the input audio signal by the classifier block 214.

Each of the plurality of masks 224-1-224-n is tailored to a particular class of input audio signal, and is configured to implement an attenuation function to attenuate rattle-causing spectral content in the input audio signal in a manner that optimises or improves a property or characteristic such as fidelity or clarity of the audio output by the audio output transducer 110 as perceived by a listener.

Thus, for example, if the classifier block 214 classifies the input audio signal as belonging to the pure tone signal class, the processing block 220 may select a first mask 226-1 of the plurality of masks 226-1-226-n to apply to the audio signal to attenuate rattle-causing spectral content in the input audio signal to optimise or at least improve the (listener-perceived) fidelity of the audio output.

Similarly, if the classifier block 214 classifies the input audio signal as belonging to the multitone signal, single instrument music or multi-instrument music class, the processing block 220 may select a mask of the plurality of masks 226-1-226-n that is tailored to the particular class to apply to the input audio signal to attenuate rattle-causing spectral content in the input audio signal to optimise or at least improve the (listener-perceived) fidelity of the audio output.

In contrast, if the classifier block 214 classifies the input audio signal as belonging to the speech class, the processing block 220 may select a mask of the plurality of masks 226-1-226-n that is tailored to the speech class to apply to the input audio signal to attenuate rattle-causing spectral content in the input audio signal to optimise or at least improve the (listener-perceived) intelligibility of the audio output.

The plurality of masks 226-1-226-n may be implemented by a plurality of filters 222-1-222-n of the kind described above with reference to FIG. 5, or may be implemented by one or more dynamically reconfigurable filters 224 of the kind described above with reference to FIG. 6.

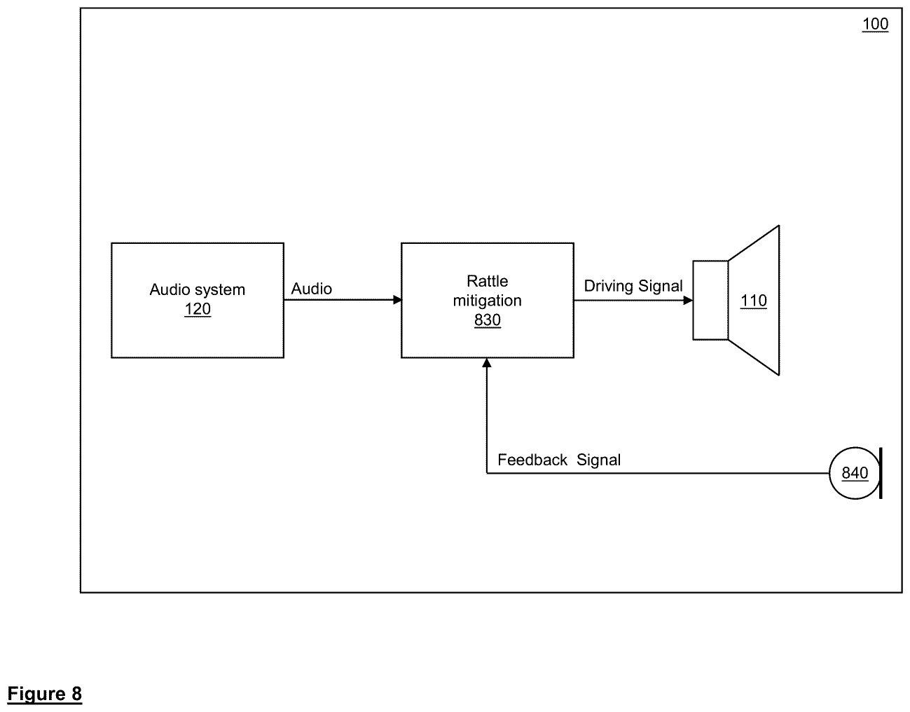

FIG. 8 is a schematic diagram illustrating the principle of closed loop rattle mitigation in an audio system of a host device in accordance with an aspect of the present disclosure. FIG. 8 has some features in common with FIG. 1, and so like features are denoted by like reference numerals in FIGS. 1 and 8.

As shown in FIG. 8, an input transducer 840 of a host device 100 such as a laptop, tablet or all in one desktop PC supplies a feedback signal to a rattle mitigation subsystem 830. The input transducer 840 may be a microphone, accelerometer or other suitable transducer of the host device 100.

The rattle mitigation subsystem 830 is configured to receive the feedback signal from the input transducer 840 while audio is being output by the audio output transducer 110, and to detect distortion due to mechanical rattle based on the feedback signal. The rattle mitigation subsystem 830 is further configured to apply countermeasures to mitigate the distortion, e.g. by applying an attenuation function to the input audio signal received by the rattle mitigation subsystem and/or by amplifying signal components of the input audio signal at masking frequencies, as described above with reference to FIGS. 1-7.

The rattle mitigation subsystem 830 may be operative to detect distortion based on the feedback signal, e.g. by comparing the feedback signal received from the input transducer 840 to the audio signal received from the audio system 120. The rattle mitigation subsystem 830 may be operative to monitor a sound pressure level (SPL) of the audio output by the audio output transducer 110 based on the feedback signal supplied by the input transducer 840, and may apply countermeasures to mitigate distortion if the SPL falls below a SPL threshold.

In an alternative example, baseband content of the audio output by the audio output transducer 110 and associated harmonics are monitored by the rattle mitigation subsystem 830 (based on the feedback signal supplied by the input transducer 840) to detect distortion.

In some examples, the rattle mitigation subsystem 130/830 may be configured to apply the attenuation function according to an attack/release function that gradually increases the level of attenuation applied to the input audio signal by the rattle mitigation subsystem 130/830. In such examples, the analyser block 210 (or another decision block) may analyse the spectral content of the input audio signal as described above to identify any signal components of the input audio signal that will give rise to mechanical rattle if supplied to the audio output transducer 110 without applying an attenuation function. If such signal components are identified, the processing block 220 may progressively apply the attenuation function over a period of time, to ramp up the attenuation applied to the input audio signal over time from a minimum attenuation level to a maximum attenuation level, such that the maximum attenuation level is applied to signal components of the input audio signal that may give rise to mechanical rattle if supplied to the audio output transducer 110 without any attenuation.

As discussed above, the processing block 220 may be operative to apply an attenuation function only if one or more predetermined conditions are met, e.g. if rattle-causing spectral content (above a threshold) is detected in the input audio signal, if a level of masking content in the input audio signal is below a threshold, if a ratio of high-frequency content to full-frequency content is below a high-frequency to full-frequency ratio threshold, if a ratio of the level of low-frequency content to high-frequency content in the audio signal is above a low-frequency to high-frequency ratio threshold. In some examples, the ratio of high-frequency content to full-frequency content in the input audio signal and/or the ratio of low-frequency content to high-frequency content in the input audio signal may be used to determine a level of engagement of the attenuation function, e.g. a percentage of the maximum attenuation level of the attenuation function applied by the processing block 220. For example, at a higher ratio of low-frequency content to high-frequency content, a higher percentage of the maximum attenuation level may be applied, whereas at lower ratios, a lower percentage of the maximum attenuation level may be applied. In some examples, the processing block 220 may perform “fast limiting” to immediately apply the maximum level of attenuation to the input audio signal if the level of engagement of the attenuation function is greater than 0.

As previously noted, the processing block 220 may be operative to process a digital audio signal on a frame-by-frame basis so as to apply appropriate processing to each frame of the digital audio signal. Thus, the attenuation function applied to a frame of the digital audio signal may be different from the attenuation function applied to a preceding or subsequent frame. The processing block 220 may be configured to perform a smoothing function to smooth the transition between different attenuation functions that are applied to adjacent frames of the input audio signal, to reduce the risk of introducing audible artefacts such as clicks and pops in the audio output. For example, the processing block 220 may be configured to perform a linear interpolation to transition from a first attenuation function applied to one frame of the input audio signal to a second attenuation function applied to a subsequent frame of the input audio signal, or to introduce an exponential decay to a transition between the first and second attenuation functions.

The processing block 220 may be operative to apply the attenuation function and/or the amplification function in the frequency domain or in the time domain. The processing block may therefore be operative to transform the time domain input audio signal to a frequency domain signal (e.g. by performing an FFT operation on the input audio signal), and to apply the attenuation function and/or the amplification function to the frequency domain signal to generate a processed frequency domain signal. This processed frequency domain signal may be transformed back into the time domain (e.g. by performing an inverse FFT operation on the processed frequency domain signal) to generate a time domain driving signal that can be supplied to the audio output transducer 110.

In some examples, the processing block 220 may be operative to selectively apply the attenuation function and/or the amplification function in the frequency domain or the time domain, based on one or more features, characteristics, properties or classifications of the input audio signal. For example, if it is important to minimise latency in the audio output, the processing block 220 may be operative to apply the attenuation function and/or the amplification function in the time domain, whereas if maximum audio fidelity is a priority the processing block 220 may be operative to apply the attenuation function and/or the amplification function in the frequency domain.

In examples in which the analyser block 210 includes a classifier block 214, the processing block 220 may be configured to selectively apply the attenuation function and/or the amplification function in the time domain or in the frequency domain based on the classification of the input audio signal. For example, if the input audio signal is classified by the classifier block 214 as belonging to the speech class, where low latency may be more important than high audio fidelity, the processing block 220 may apply the attenuation function and/or the amplification function in the time domain. In contrast, if the audio signal is classified by the classifier block 214 as belonging to the single instrument music class or the multi-instrument music class, where audio fidelity may be more important than low latency, the processing block 220 may apply the attenuation function and/or the amplification function in the frequency domain.

In examples in which the analyser block 210 does not include a classifier block, the processing block 220 may be configured to selectively apply the attenuation function and/or the amplification function based on features of the input audio signal identified by the analyser block 210 that may be indicative of the type of content represented by the audio signal. For example, if the features of the input audio signal are indicative that the input audio signal represents speech, where low latency may be more important than high audio fidelity, the processing block 220 may apply the attenuation function and/or the amplification function in the time domain. In contrast, if the features of the input audio signal are indicative that the input audio signal represents single instrument or multi-instrument music, where audio fidelity may be more important than low latency, the processing block 220 may apply the attenuation function and/or the amplification function in the frequency domain. Those of ordinary skill in the art will readily appreciate how to detect features of an audio signal that are indicative of the type of audio content represented by the audio signal.

As previously noted, the frequency or frequencies of spectral content of the input audio signal that may give rise to mechanical rattle of the host device 100 are specific to the particular host device 100, in that they are dependent on the properties and/or configuration of the host device 100. Thus, in order to configure the rattle mitigation subsystem 130 of a particular host device 100, it is necessary to determine or evaluate the characteristic behaviour of the host device 100 to identify the frequency or frequencies of spectral content of the input audio signal that may give rise to mechanical rattle of the host device 100. Once the characteristic behaviour of the host device 100 has been determined or evaluated, the analyser block 210 can be configured with appropriate frequency or frequency band information and thresholds to enable it to identify rattle-causing components of the input audio signal, the classifier block 214 (if present) can be appropriately configured (e.g. provided with suitable weights or the like) and the filter(s) 222-2-222-n, 224 and/or masks 226-1-226-n of the processing block 220 can be appropriately configured (e.g. provided with suitable filter coefficients or the like).

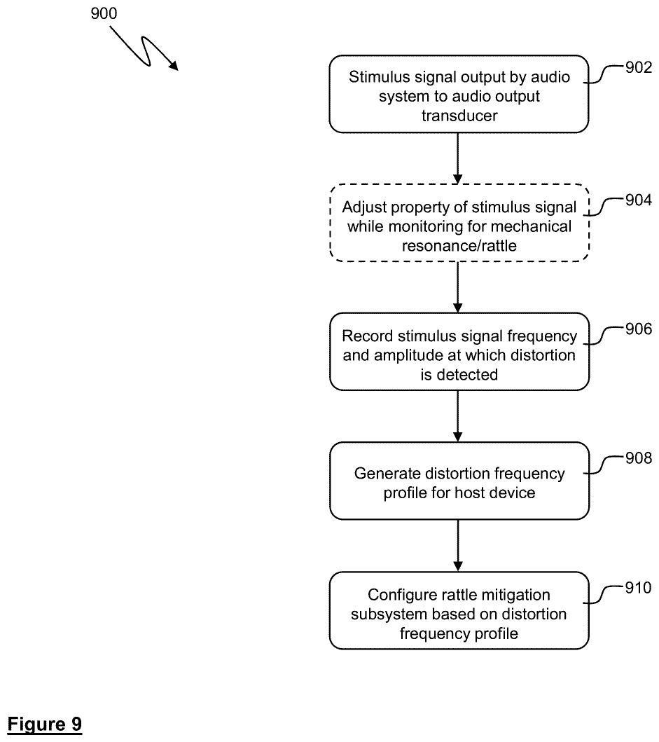

FIG. 9 is a flow chart showing steps in a method 900 for determining or evaluating the characteristic acoustic behaviour of a host device 100. The method 900 may be performed, for example, during a tuning stage that may be of an assembly or initial set-up process of the host device 100.

In a first step 902 of the method, a stimulus signal is output by the audio system 120. In this step, no attenuation function or amplification function is applied by the rattle mitigation subsystem 130, 830, such that the stimulus signal is supplied as a driving signal to the audio output transducer 110. The stimulus signal may comprise, for example, a single-tone signal of variable frequency and amplitude, or a multi-tone signal, where the frequency and amplitude of each constituent tone are variable. The stimulus signal may be configured to simulate an audio signal that would be output by the audio system 120 in use of the host device 100.

At step 904, one or more properties of the stimulus signal are adjusted while the host device 100 is monitored for mechanical rattle or other mechanical resonance effects. For example, the frequency of the stimulus signal (or of one or more constituent tones of the stimulus signal, in the case of a multi-tone stimulus signal) may be swept through a predefined frequency range (e.g. 20 hz-20 kHz) while maintaining the amplitude of the stimulus signal (or its constituent tones) constant, and while monitoring the host device 100 for mechanical rattle or other mechanical resonance effects. Alternatively, the amplitude of the stimulus signal may be adjusted over a predefined range from a minimum amplitude to a maximum amplitude while maintaining the frequency of the stimulus signal (or its constituent tones) constant, and while monitoring the host device 100 for mechanical rattle or other mechanical resonance effects.

The frequency (or frequencies) and amplitudes of the stimulus signal at which mechanical rattle or another mechanical resonance effect is detected are recorded (step 906) to generate a distortion frequency profile for the host device 100 (step 908), which can subsequently be used (at step 910) to configure the rattle mitigation subsystem 130, 830 with suitable thresholds, frequencies, weights, masks, etc., as described above, to attenuate rattle-causing signal components of the input audio signal input to the rattle mitigation subsystem and/or to amplify rattle-masking components of the input audio signal to generate the driving signal for driving the audio output transducer.

The host device 100 may be monitored for mechanical rattle or other mechanical resonance effects using an input transducer such as a microphone, accelerometer or the like of the host device 100. Alternatively, an external transducer such as a microphone, accelerometer or the like of a distortion monitoring system external to the host device 100 may be used to monitor the host device 100 for mechanical rattle or other mechanical resonance effects.

In an alternative example of the method 900, the stimulus signal may comprise a plurality of tones, which may be of fixed amplitude, spaced apart from each other in frequency. Applying a stimulus signal of this kind may facilitate faster identification of frequencies that give rise to mechanical rattle or other mechanical resonance effects in the host device 100. When such a stimulus signal is applied, step 906 of the method may be unnecessary.

The host device 100 may have a plurality of audio output transducers. Steps 902-908 of the method 900 described above with reference to FIG. 9 may be performed separately for each of the plurality of audio output transducers to generate a plurality of distortion frequency profiles, one for each of the plurality of audio output transducers. The rattle mitigation subsystem 130, 830 may be configured with suitable thresholds, frequencies, weights, masks, etc., based on the plurality of distortion frequency profiles, as described above, to attenuate rattle-causing signal components of the input audio signal input to the rattle mitigation subsystem and/or to amplify rattle-masking components of the input audio signal to generate driving signals for driving each of the plurality of audio output transducers.

In addition to performing the method 900 during a tuning stage of an assembly or initial set-up process of the host device 100, the method 900 may also be performed periodically or in response to a trigger condition, after assembly or set-up of the host device 100, to update the rattle mitigation subsystem 130, 830 with updated thresholds, frequencies, weights, masks, etc., to account for ageing of the host device 100, audio output transducer(s) 110 and rattle mitigation subsystem 130, 830 and/or changes in the physical environment in which the host device 100 is used. When performing the method 900 for such updating, an input transducer such as input transducer 840 is used for monitoring the audio output signal(s) of the audio output transducer(s) 110.

As will be appreciated by those of ordinary skill in the art, the problem of mechanical rattle or resonance is not unique or specific to computing devices. Mechanical rattle or other undesirable effects arising from mechanical resonance at audio frequencies may also occur in other applications in which an audio output transducer is mechanically coupled to a part of a host device, e.g. in automotive audio systems in which speakers are mechanically mounted on or otherwise coupled to panels of the interior of the vehicle. The system and method described herein are applicable to such other applications. Accordingly, the present disclosure extends to a system for mitigating mechanical rattle more generally, and to a system for mitigating resonance at audio frequencies.

The system described above with reference to the accompanying drawings may be incorporated in a host device such as a laptop, notebook, netbook or tablet computer, an all-in-one computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device, a vehicle such as a car, van truck or the like.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog ™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A computer having a system for mitigating mechanical rattle arising due to a mechanical coupling of an audio output transducer to a part of the computer device, the system comprising:
a processing subsystem configured to receive an input audio signal and to output a drive signal for driving the audio output transducer to produce a transducer output,
wherein the processing subsystem is configured to selectively apply an attenuation function to the input audio signal to attenuate a signal component of the input audio signal at a frequency that causes mechanical rattle in the computer; and
an analyser subsystem configured to receive the input audio signal and to output a control signal to the processing subsystem to control application of the attenuation function to the input audio signal by the processing subsystem based on a spectral content of the received input audio signal;
wherein the attenuation function is based on characteristic acoustic behaviour of the computer.

2. The computer of claim 1, wherein the processing subsystem is further configured to selectively apply an amplification function to the input audio signal to amplify a signal component of the input audio signal at a frequency that masks an effect of mechanical rattle in the computing device.

3. The computer of claim 1, wherein the analyser subsystem comprises a classifier configured to classify the input audio signal into one or more classes based on the spectral content of the input audio signal and to output a control signal to the processing subsystem to control application of the attenuation function to the input audio signal by the processing subsystem based on the classification of the input audio signal.

4. The computer of claim 3, wherein the classifier comprises a neural network or machine learning model trained to:
identify features of the input audio signal that are characteristic of each of the one or more classes and:
classify the input audio signal based on identified features of the input audio signal; or
determine a metric relating to identified features of the input audio signal and to classify the input audio signal based on the metric.

5. (canceled)

6. The computer of claim 1, wherein the analyser subsystem is configured to output the control signal in response to detection of spectral content in the input audio signal at a level above a rattle threshold at a frequency that could give rise to mechanical rattle in the computing device.

7. The computer of claim 1, wherein the analyser subsystem is configured to determine a first ratio of high-frequency content to low-frequency content of the input audio signal and/or a second ratio of low-frequency content to high-frequency content of the input audio signal, and to output a control signal to the processing block to control application of the attenuation function based on the determined first and/or second ratio.

8. The computer of claim 1, wherein the analyser subsystem is configured to perform a fast Fourier Transform (FFT) on the input audio signal to generate a frequency-domain representation of the input audio signal received by the analyser block.

9. The computer of claim 8, wherein the analyser subsystem is configured to output the control signal in response to detection of a signal peak in the frequency domain representation of the input audio signal at a frequency that could give rise to mechanical rattle in the computing device.

10. The computer of claim 9, wherein the analyser subsystem is configured to output the control signal in response to detection of a signal peak in the frequency domain representation of the input audio signal at a level above a rattle threshold at a frequency that could give rise to mechanical rattle in the computing device.

11. The computer of claim 8, wherein the analyser subsystem is configured to determine a ratio of a level of a detected high-frequency signal peak in the frequency-domain representation of the input audio signal to a level of a detected low-frequency signal peak in the frequency-domain representation, and to output the control signal if the determined ratio exceeds a frequency content ratio threshold.

12. The computer of claim 1, wherein the analyser subsystem is configured to prevent the processing subsystem from applying the attenuation function in response to detection of spectral content in the input audio signal at a frequency that may mask mechanical rattle in the computer.

13. The computer of claim 12, wherein the analyser subsystem is configured to prevent the processing subsystem from applying the attenuation function in response to detection of spectral content in the input audio signal at a level above a rattle-masking threshold at a frequency that may mask mechanical rattle in the computer.

14. The computer of claim 2, wherein the analyser subsystem is configured to output a control signal to cause the processing subsystem to apply the amplification function in response to detection of spectral content in the input audio signal at a frequency that may mask mechanical rattle in the computer.

15. The computer of claim 1, wherein the input audio signal is a digital signal comprising a plurality of frames, wherein for each frame of the input audio signal, the analyser subsystem is operative to output a control signal to the processing subsystem to control application of the attenuation function or to prevent the processing subsystem from applying the attenuation function based on the spectral content of the frame.

16. The computer of claim 1, wherein the processing subsystem comprises one or more filters configured to implement the attenuation function, wherein the or each filter comprises:
a narrowband; or
a dynamically reconfigurable filter having a controllable transfer function, wherein the processing subsystem is configured to control the transfer function of the or each dynamically reconfigurable filter based on a control signal received from the analyser subsystem, wherein the or each filter comprises a time domain-filter or a frequency-domain filter.

17.-19. (canceled)

20. The computer of claim 3, wherein the processing subsystem is configured to selectively apply one or more masks to the input audio signal based on the classification of the input audio signal by the classifier, wherein the or each mask is configured to implement an attenuation function to attenuate rattle-causing spectral content in the input audio signal to optimise or improve a property of the transducer output signal.

21. The computer of claim 20, wherein the processing system is configured to apply a first mask to optimise or improve fidelity of the transducer output in response to a classification of the audio input signal as music, and to apply a second mask to optimise or improve intelligibility of the transducer output in response to a classification of the audio input signal as speech.

22. The computer of claim 1, wherein the computer comprises an input transducer, and wherein the processing subsystem is configured to:
receive a feedback signal from the input transducer;
detect distortion in the transducer output based on the feedback signal; and
in response to detection of distortion in the transducer output, apply the attenuation function and/or an amplification function to the audio input signal.

23. The computer of claim 22, wherein the processing subsystem is configured to monitor one or more of a sound pressure level of the transducer output and baseband content and associated harmonics of the transducer output based on the feedback signal to detect distortion in the transducer output.

24. The computer of claim 1, wherein the processing subsystem is configured to apply the attenuation function according to an attack/release function.

25. The computer of claim 24, wherein the processing subsystem is configured to progressively apply the attenuation function to the input audio signal over a period of time, from a minimum attenuation level to a maximum attenuation level such that the maximum attenuation level is applied to spectral content of the input audio signal at a frequency that could give rise to mechanical rattle in the computing device.

26. The computer of claim 3, wherein the processing subsystem is configured to selectively apply the attenuation function in the time domain or in the frequency domain based on the classification of the input signal by the classifier.

27. The computer of claim 26, wherein the processing subsystem is configured to apply the attenuation function in the time domain in response to a classification of the audio input signal as speech, and to apply the attenuation function in the frequency domain in response to a classification of the audio input signal as music.

28. The computer of claim 1, wherein the processing subsystem is configured to selectively apply the attenuation function in the time domain or in the frequency domain based on identification of features of the input audio signal by the analyser subsystem.

29. The computer of claim 28, wherein the processing subsystem is configured to apply the attenuation function in the time domain in response to identification of feature of the audio input signal indicative that the audio input signal represents speech, and to apply the attenuation function in the frequency domain in response to identification of features of the audio input signal indicative that the audio input signal represents music.

30.-34. (canceled)

35. A system for mitigating mechanical rattle in a computer arising due to a mechanical coupling of an audio transducer to a part of the computer, the system comprising:
a classifier subsystem configured to classify the audio input signal into one or more of a plurality of classes; and
a processing block configured to selectively apply an attenuation function to the input signal to attenuate a signal component of the input audio signal according to the classification of the audio input signal.

36.-37. (canceled)

38. A system for mitigating mechanical resonance in a host device arising due to a mechanical coupling of an audio output transducer to a part of the host device, the system comprising:
a processing subsystem configured to receive an input audio signal and to output a drive signal for driving the audio output transducer to produce a transducer output,
wherein the processing subsystem is configured to selectively apply an attenuation function to the input audio signal to attenuate a signal component of the input audio signal at a frequency that causes mechanical resonance in the host device.

39. An integrated circuit implementing the system of claim 38.

40. The integrated circuit of claim 39, wherein the integrated circuit comprises a smart amplifier integrated circuit.

41. A host device comprising the system of claim 38, wherein the host device comprises a laptop, notebook, netbook or tablet computer, an all-in-one computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device, or a vehicle.

42. (canceled)
